(19) United States
(12) Patent Application Publication
(10) Pub. No.: US 2025/0348815 A1
(43) Pub. Date: Nov. 13, 2025

(54) WAREHOUSE MACHINE AND WORKFLOW IMPLEMENTATION SYSTEM

(71) Applicant: Triage Partners Holdings, LLC, Tampa, FL (US)

(72) Inventors: Joseph T. Cochran, Tallmadge, OH (US); Kristofor Erickson, Tampa, FL (US)

(21) Appl. No.: 19/204,159

(22) Filed: May 9, 2025

Related U.S. Application Data
(60) Provisional application No. 63/644,806, filed on May 9, 2024.
(60) Provisional application No. 63/762,813, filed on Feb. 25, 2025.

(51) Int. Cl. G06Q 10/0633; G06N 20/00; G06Q 10/10

(52) U.S. Cl. CPC G06Q 10/0633; G06N 20/00; G06Q 10/103

(57) ABSTRACT

Methods and systems are described for dynamic machine and workflow management in warehouses or other logistics centers. Embodiments include the ability of a user to automatically add new machines to logistics workflows, including the ability to automatically create and add APIs for provisioning of new machines and devices for use at workstations in a logistics workflow. Workers can be presented with precise workflows, with defined options given for possible variables throughout the process. Embodiments can provide quick implementation of new machines and associated workflows, saving time and money when instituting new processes. Embodiments of machines and other components can allow for detailed data collection regarding logistics workflows, which can help identify problems and lead to money and time savings.

### CROSS REFERENCE TO RELATED INFORMATION

This application claims the benefit of United States of America priority application No. 63/762,813 filed on Feb. 25, 2025, titled “Warehouse Machine and Workflow Implementation System,” and United States of America priority application No. 63/644,806 filed on May 9, 2024, titled “Warehouse Machine and Workflow Implementation System,” the contents of which are hereby incorporated herein in their entirety.

### TECHNICAL FIELD

The present disclosure generally relates to systems and methods for dynamically creating and updating logistics workflows and machines at logistic-focused work centers.

### BACKGROUND

There are a variety of logistic and supply chain locations that rely on many workers to accurately carry out detailed workflows. For example, some factories or warehouses may specialize in processing, fixing, rejecting, and performing other tasks related to the refurbishing of smartphones. In another example, a factory may focus on building automobiles. Providing all workers in the “assembly line” or process flow with accurate instructions, adjusted dynamically based on progress within a larger process and/or based on variables (e.g., phone condition, missing parts, and others) can be difficult. It is also challenging to provide detailed workflows and instructions while also tracking worker productivity and resource usage.

### SUMMARY

One embodiment under the present disclosure comprises a system for dynamically managing logistics-based workflows at one or more workstations. The system comprises: one or more workstations operable by one or more workers to complete one or more steps in a workflow; one or more computing devices located at the one or more workstations, each of the one or more computing devices configured to display respective steps of the one or more steps that are associated with each respective workstation of the one or more workstations, the respective steps to be completed by a respective worker of the one or more workers; and at least one machine coupled to at least one workstation of the one or more workstations, the at least one machine operable by a respective worker of the one or more workers to complete respective steps of the one or more steps in the workflow. It further comprises at least one manager computing device coupled to the one or more computing devices and configured to provide the respective steps to each of the one or more computing devices, the at least one manager computing device further configured to allow a user to edit the one or more steps and to create one or more application programming interfaces (APIs) for implementing the respective steps for completion by the at least one machine.

Another embodiment under the present disclosure comprises a method of dynamically managing logistics-based machines with associated workflows. The method comprises: presenting, to a user via at least one manager computing device, a workflow editing interface to allow the user to create a workflow defining; one or more steps of the workflow to be completed by one or more workers; one or more workstations operable by one or more workers to complete the one or more steps; one or more computing devices located at the one or more workstations, each of the one or more computing devices configured to display respective steps of the one or more steps that are associated with each respective workstation of the one or more workstations, the respective steps to be completed by a respective worker of the one or more workers; and at least one machine coupled to at least one workstation of the one or more workstations, the at least one machine operable by a respective worker of the one or more workers to complete respective steps of the one or more steps in the workflow. The method further comprises: presenting, to the user via the at least one manager computing device, an API dashboard to allow the user to create one or more APIs for implementing the at least one machine into the workflow; transmitting each respective step to each respective computing device for display to the one or more workers; and implementing the at least one machine via the one or more APIs.

Another embodiment under the present disclosure comprises a computer implemented method for training a machine learning model for optimizing a workflow implementation system. The method comprises: obtaining a dataset of identified logistics workflow outcomes; training the machine learning model using the dataset of identified logistics workflow outcomes thereby obtaining a trained machine learning model, and storing the trained machine learning model.

Another embodiment under the present disclosure comprises a system for dynamically adding or editing logistics-based machines and/or associated workflows. The system comprises: processing circuitry; and a memory. The memory contains instructions executable by the processing circuitry whereby the system is operative to perform the steps of: presenting, to a user via at least one manager computing device, a workflow editing interface to allow the user to create a workflow defining; one or more steps of the workflow to be completed by one or more workers; one or more workstations operable by one or more workers to complete the one or more steps; one or more computing devices located at the one or more workstations, each of the one or more computing devices configured to display respective steps of the one or more steps that are associated with each respective workstation of the one or more workstations, the respective steps to be completed by a respective worker of the one or more workers; and at least one machine coupled to at least one workstation of the one or more workstations, the at least one machine operable by a respective worker of the one or more workers to complete respective steps of the one or more steps in the workflow. The steps further comprise: presenting, to the user via the at least one manager computing device, an application programming interface, API, dashboard to allow the user to create one or more APIs for implementing the at least one machine into the workflow; transmitting each respective step to each respective computing device for display to the one or more workers; and implementing the at least one machine via the one or more APIs.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates one embodiment of an workflow and machine editing system under the present disclosure;

FIG. 2 shows an example user interface embodiment under the present disclosure;

FIG. 3 shows an example user interface embodiment under the present disclosure;

FIG. 4 shows an example user interface embodiment under the present disclosure;

FIG. 5 shows an example user interface embodiment under the present disclosure;

FIG. 6 shows an example user interface embodiment under the present disclosure;

FIG. 7 shows an example user interface embodiment under the present disclosure;

FIG. 8 shows an example user interface embodiment under the present disclosure;

FIG. 9 shows an example user interface embodiment under the present disclosure;

FIG. 10 shows an example user interface embodiment under the present disclosure;

FIG. 11 shows an example user interface embodiment under the present disclosure;

FIG. 12 shows an example user interface embodiment under the present disclosure;

FIG. 13 shows an example user interface embodiment under the present disclosure;

FIG. 14 shows an example user interface embodiment under the present disclosure;

FIG. 15 shows an example user interface embodiment under the present disclosure;

FIG. 16 shows an example user interface embodiment under the present disclosure;

FIG. 17 shows an example user interface embodiment under the present disclosure;

FIG. 18 shows an example user interface embodiment under the present disclosure;

FIG. 19 shows an example user interface embodiment under the present disclosure;

FIG. 20 shows an example data collection user interface embodiment under the present disclosure;

FIG. 21 shows an example flow chart of training and inference pipelines for machine learning in accord with some embodiments under the present disclosure;

FIG. 22 shows an embodiment of a neural network under the present disclosure;

FIG. 23 shows an embodiment of a possible method embodiment under the present disclosure; and

FIG. 24 shows an embodiment of a computing device for use in various embodiments under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

As described above, there currently exist certain challenges in the realm of warehouse and supply chain management and workflow systems. Current systems struggle to present accurate and detailed instructions to workers, with the ability to dynamically adjust to variables. Variable could be e.g.: phone condition (for smartphone refurbishment systems), error messages on networked machines, current status within a larger process or workflow, or other variables. Current systems also struggle to automatically or quickly achieve interoperability with new machinery, such as new computer, printers, factory machines, or other components. Current systems also fail to track metrics throughout a workflow, such as machine condition, worker productivity, or other factors.

Certain aspects of the embodiments disclosed herein provide solutions to these or other challenges. Embodiments include systems and workflow for dynamic workflows and workflow management. Embodiments of the present disclosure can provide dynamic workflows for use in logistics or supply chain management such as in factories or warehouses. Workers can be presented with precise workflows, with defined options given for possible variables throughout the process (e.g., phone condition, process status). Administrators can also design new workflows and can integrate new machines or components on the fly.

Certain embodiments may provide one or more of the following technical advantages. Certain embodiments provide quick implementation of reconfigured or edited workflows, saving time and money when instituting new workflows. Automatic or quick integration of new machinery or components also saves time and money. Certain embodiments, by allowing detailed workflows and data tracking can help identify problems in a given workflow, also leading to money and time savings.

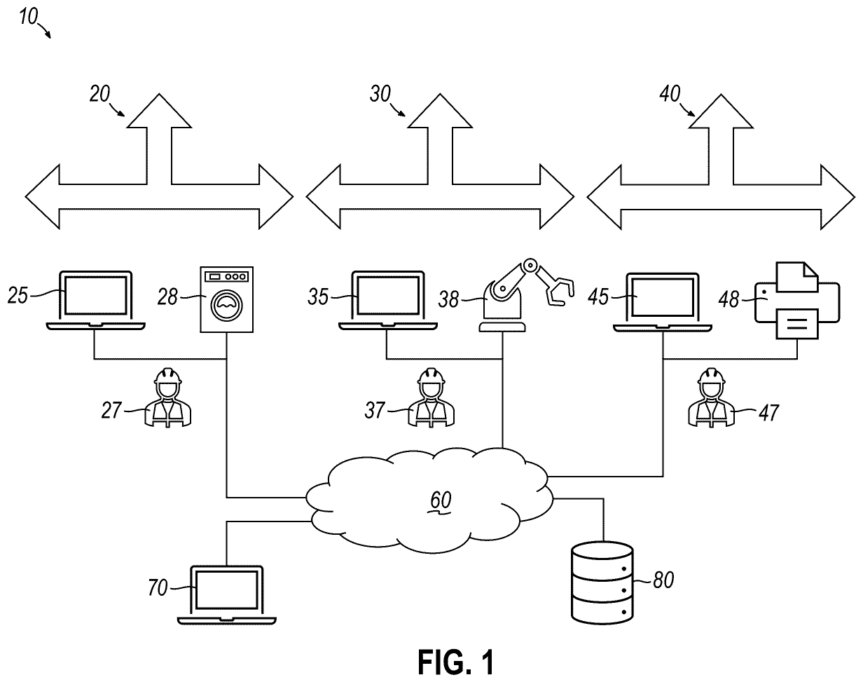

FIG. 1 illustrates one system embodiment 10 under the present disclosure. A workflow 8 can begin at process start 5 and end at process end 50. Stations 20, 30, 40 are in workflow 8, although a given workflow could have any number of stations or discreet steps, locations, logical steps, or other types/means of dividing up a process or workflow. System 10 may comprise a factory, refurbishing location, or any of a variety of manufacturing or logistics locations. Each station 20, 30, 40 can comprise a computing device 25, 35, 45 (e.g., laptop, computer, server, smartphone, etc.) usable by a worker 27, 37, 47. Each station 20, 30, 40 may also comprise a machine 28, 38, 48 (e.g., a microscope, printer, computer, factory machinery/arm, packaging machine, washer, etc.). These examples are provided by way of example only. In practice a station may or may not have a computing device or machine, or could have multiple instances of these, depending on the type of workflow. In some embodiments a given object (e.g., a smartphone being refurbished) may be passed along stations 20, 30, 40 by various means (e.g., a conveyor belt, by hand, or other means). In other embodiments an object may stay in one place and workers 27, 37, 47 may physically move from station to station. Computing device(s) 70 (e.g. laptop, smartphone, tablet, server, etc.) can allow a manager to define workflow 8, e.g., by defining steps to be followed at each station 20, 30, 40, e.g., by presenting predefined steps via computing devices 25, 35, 45 to workers 27, 37, 47. Workflow 8, as defined by e.g., a manager, can be stored at computing device 70 or server(s) 80 and communicated to computing devices 25, 35, 45 via network 60 (e.g., the internet, enterprise networks, cellular networks, satellite, other networks, and/or combinations of the foregoing). In some embodiments computing device(s) 70 and/or server(s) 80 can be co-located at the location of computing devices 25, 35, 45 or may even comprise one or more of computing devices 25, 35, 45. In some embodiments computing devices 25, 35, 45 may comprise machines 28, 38, 48, or machines 28, 38, 48 could be said to comprise software programs/applications running on computing devices 25, 35, 45. Both cloud-based and on-premises embodiments of system 10 (e.g., computing device 70 and/or server 80) are possible. In on-premises embodiments e.g., a Wipit agent can run on-premises and manage system 10. In cloud-based embodiments, server(s) 80 may store workflows for a variety of locations for different clients, which can be deployed as needed/instructed by a user associated with a specific location.

Computing device 70 can be used to define workflow 8. Embodiments under the present disclosure include allowing a manager/user to define a variety of aspects of workflow 8. Workflow 8 can comprise a plurality of tasks, check boxes, questions, yes/no questions, open questions, or other to do items for each of one or more stations 20, 30 40 within workflow 8. Embodiments can also allow a user to incorporate a variety of machines 28, 38, 48. Each machine 28, 38, 48, may allow for different steps, task, questions, etc. Embodiments can also allow a user to add new machines. For example, workflow 8 might comprise only stations 20 and 30, at one point in time. New machine 48 could be added to the capabilities of system 10, and the user could install machine 48, create station 40, and create steps/portions of workflow 8 related to machine 48 and station 40 and add these to workflow 8. System 10 can also use APIs to detect or request other valuable data, such as weather at a given location, or image recognition services that may be useful during logistics processes.

Embodiments can also allow a user to remotely and/or dynamically update workflow 8. For instance, one of machines 28, 38, 48 and/or computing devices 25, 35, 45 could be replaced with a new device (e.g., a new computer model, or a more capable machine) and workflow 8 can be adjusted to account for any changes necessitated by the new device. A new machine could be communicatively coupled to system 10 and system 10 can automatically download, e.g., an API (application programming interface) for integrating the new machine into system 10 and/or workflow 8. Both http (hypertext transfer protocol) and restful interfaces can be used for connecting to various machines or software running within system 10. System 10 can also interact with e.g., warehouse management systems (WMS). A WMS can comprise systems and/or software for assisting enterprises in the management of warehouse processes and operations. WMS software systems can comprise one aspect of supply chain management. Some can enable real-time visibility of inventory, in warehouses and possibly during shipping. WMS can sometimes be used by system 10 to handle inventory tracking and/or traffic directing of conveyor belts. WMS can be good at tracking where items are, such items coming and going out of a factory. But WMS tend to not be good at routing things from step to step for series of operations, such as in workflows illustrated under the present disclosure.

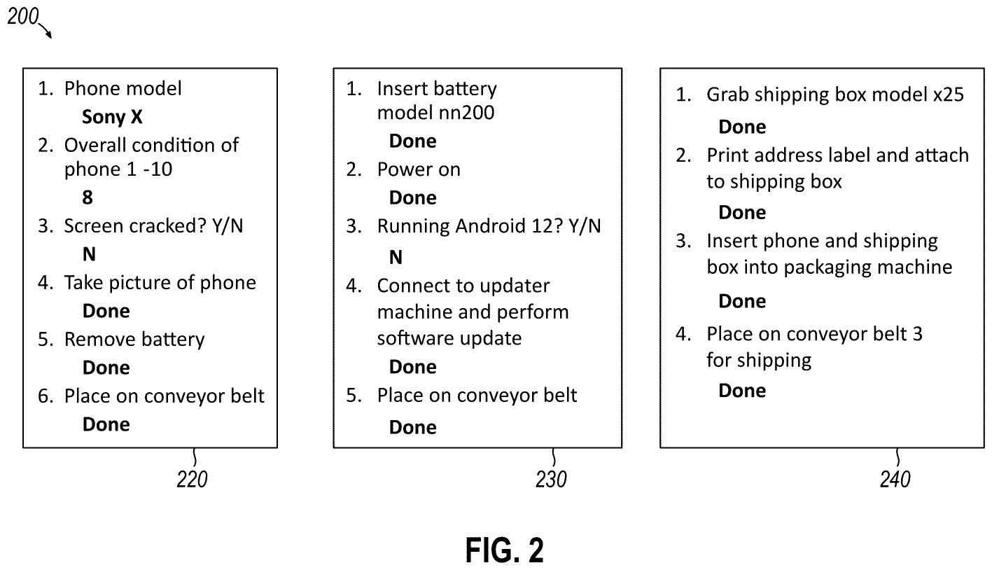

In one potential embodiment under the present disclosure, system 10 could be implemented in a smartphone refurbishing center. By way of example only, for the purpose of illustrating one possible workflow 8 of FIG. 1, user interfaces 220, 230, 240 are presented in FIG. 2 in a workflow 200. User interfaces could be presented at e.g., stations 20, 30, 40 of FIG. 1 via computing devices 25, 35, 45. Workflow 200 comprises a smartphone refurbishment process flow. As shown in FIG. 2, user interfaces 220, 230, 240 illustrate both questions posed to a worker, and worker responses. At station 20, for example, a worker could be presented with user interface 220, asking for phone model, overall condition of phone, if the screen is cracked, and instructions to remove battery and place it on conveyor belt. One instruction might ask for a picture of the phone. This instruction could automatically turn on a camera comprising computing device 25, or another camera at station 20. Questions can be yes/no, or can have predefined answers (such as a list of phone models), or open ended. In this case the screen is not cracked. If the screen were cracked, the user interface 220 could be programmed to instruct the worker to put the phone on a different conveyor belt that enters a repair process defined within workflow 200. At the next station 30, the user interface 230 instructs the worker to insert a specific battery model (based on the received smartphone model identification in user interface 220), power the phone on, check which version of Android is running, perform an operating system update with an updater machine, then place the phone on a conveyor belt for station 40. The battery model and/or Android version questions/instructions can be dynamically adjusted based on input from previous answers. User interface 240 can be presented to the worker at station 40. User interface 240 generally prepares the phone for shipping. A specific shipping box is indicated, an address label is printed, a packaging machine packages the phone in the shipping box, and the box is put on a specific conveyor belt. Again, items like a specific shipping box or conveyor belt can be dynamically adjusted by the system depending on answers to previous questions in workflow 200. For example, the shipping label might indicate a location in the western United States, which is indicated for conveyor belt 3 for shipping.

FIG. 2 is just one illustration of a possible logistics process flow. Other process and workflows are possible in factories, logistics centers, and other locations.

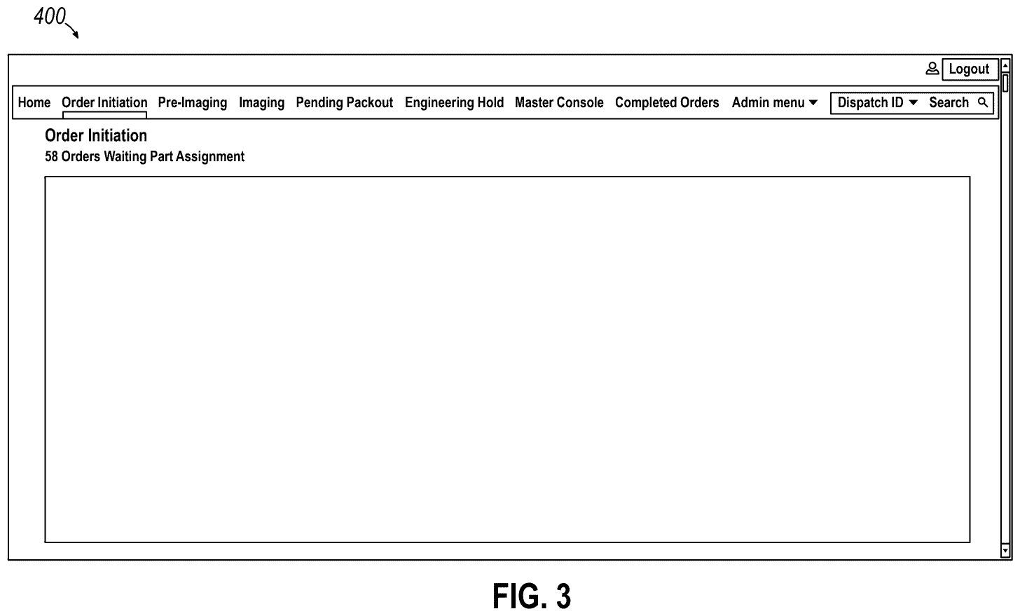

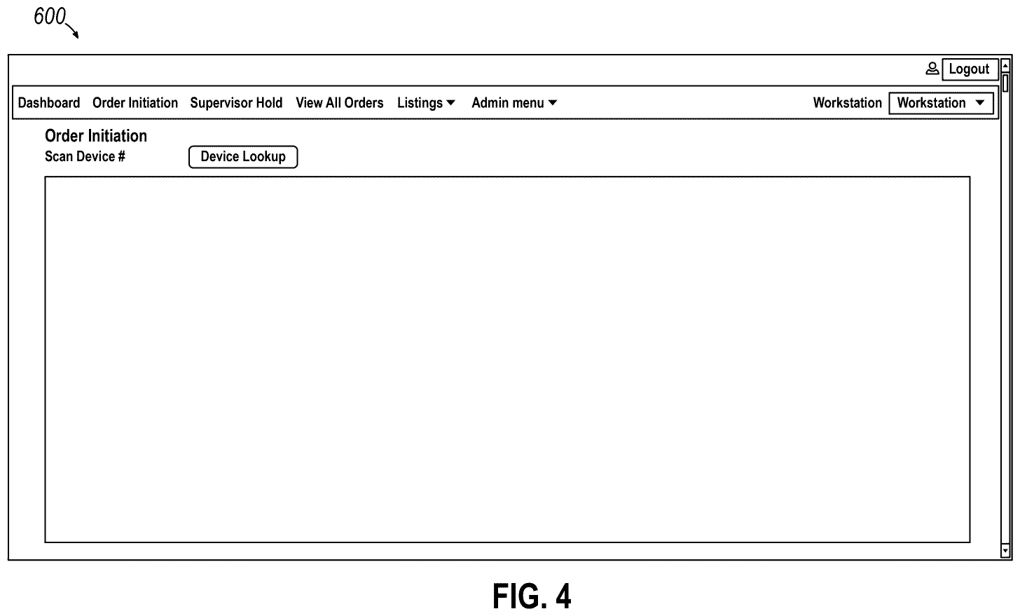

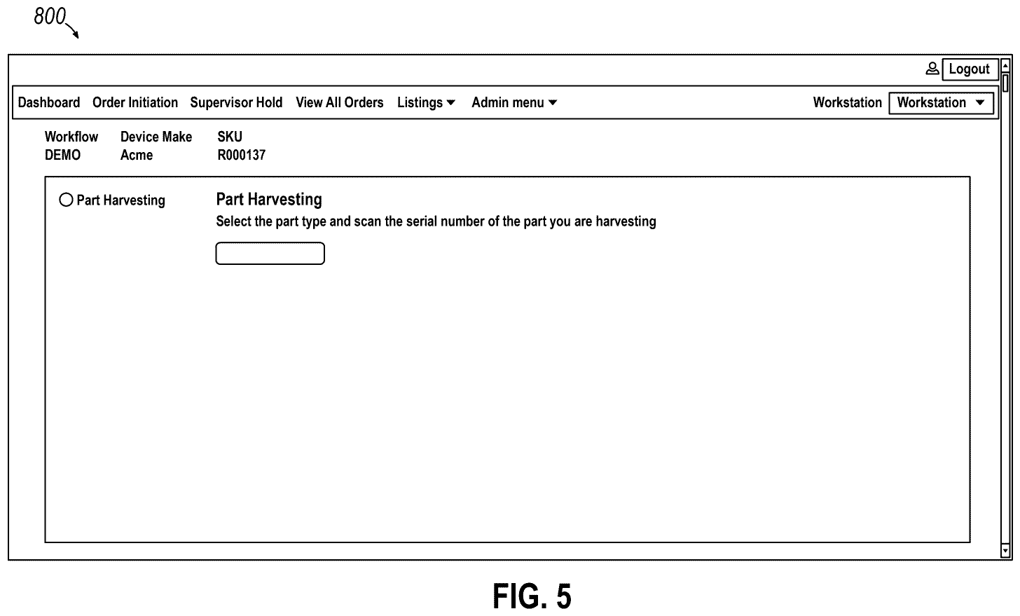

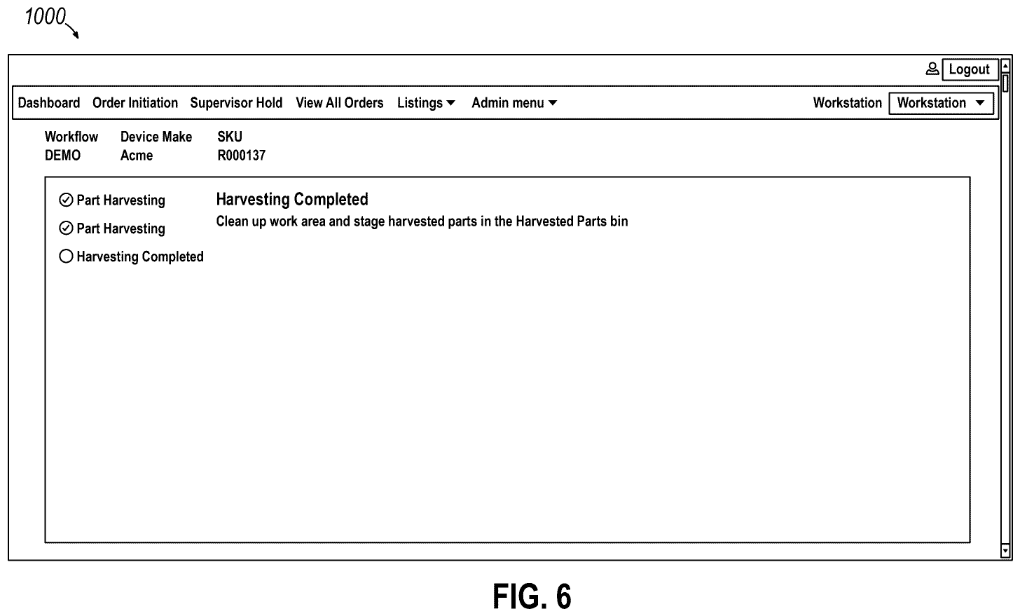

Another example of a possible workflow 450 is shown in FIGS. 3-6. User interfaces 400, 600, 800, 1000 can comprise portions of workflow 450. Workflow 450 is a process for harvesting parts from computers. A worker might begin at user interface 400, which provides a list of computers being processed. The user might select the next computer in the list, pick up that computer and return to a workstation. At the workstation, the worker may have to input a computer identification number at user interface 600. The specific computer identification number can already be associated with a device type, manufacturer, or other information in the system. The worker can then be led by the system through a number of harvesting pages, such a user interface 800, for harvesting parts such as batteries, memory, processors, etc. Upon completion, the worker may see user interface 1000, indicating that harvesting is complete. During workflow 450 there could be additional pages or steps for the worker to complete, such as indicating a condition or make of a given component, such as a processor manufacturer. Upon completion, the worker might be instructed to put certain parts on conveyor belt(s) or in certain boxes for shipment, and to pick up a new computer in the list of user interface 400 to begin the process again.

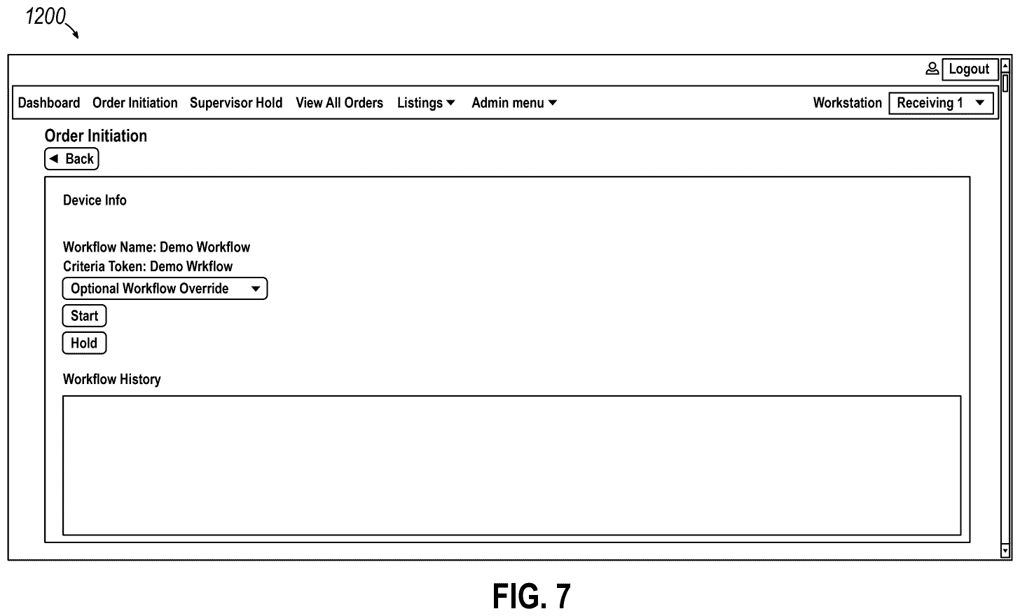

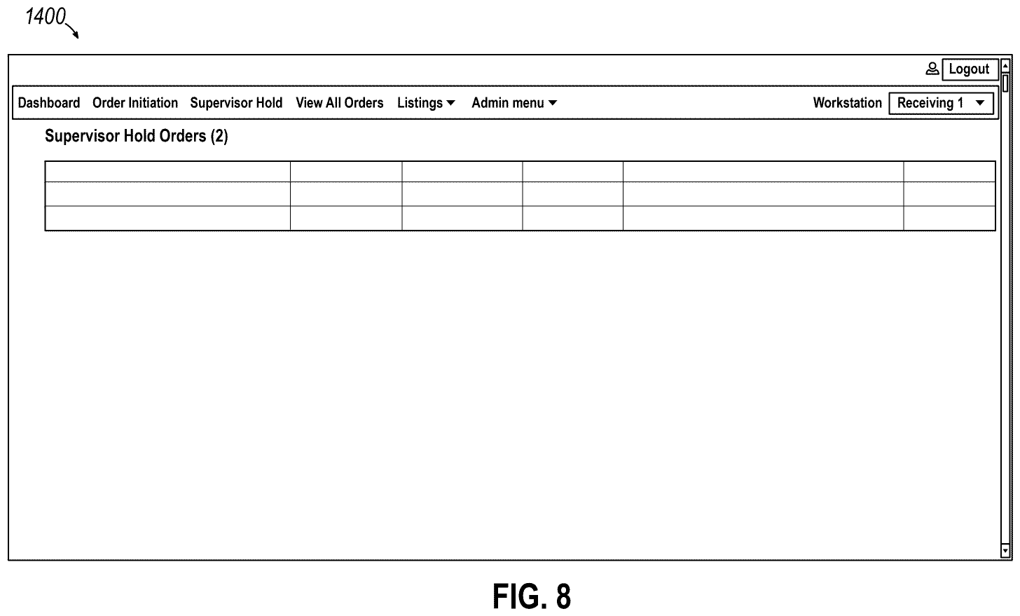

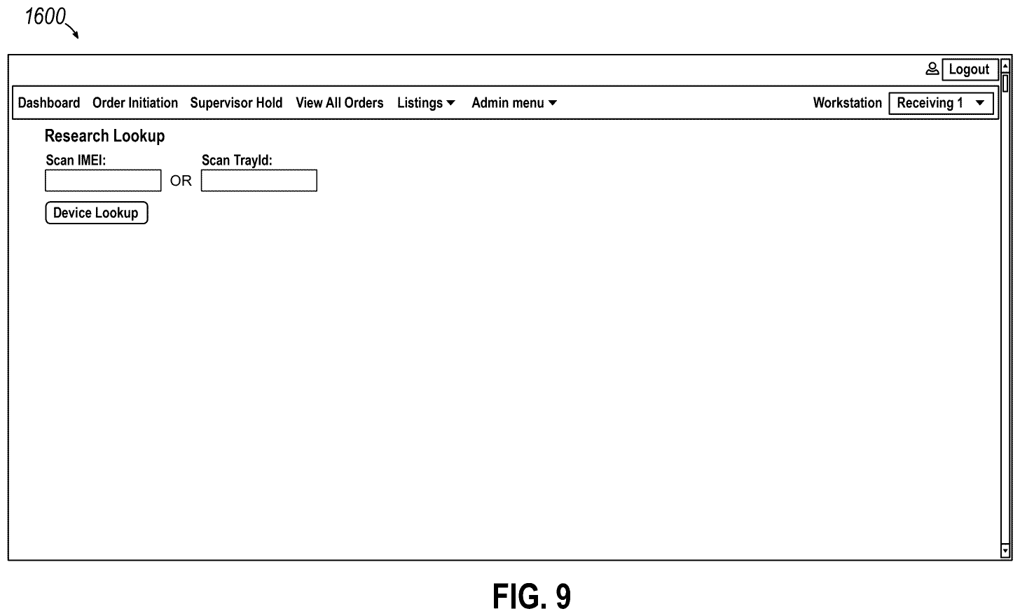

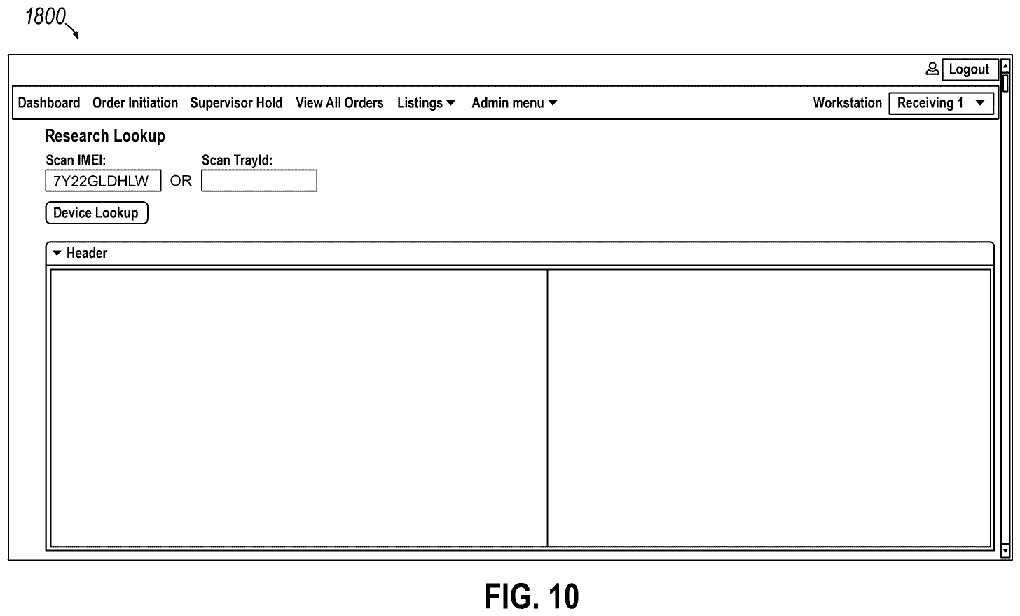

Certain embodiments can enable supervisor hold or research lookup functionalities. These are illustrated in FIGS. 7-10. In supervisor hold interfaces 1200 and 1400 of FIGS. 7 and 8, a supervisor might have associated certain devices/phones/computers being processed as ‘hold’ devices for some reason. Or a worker might reach a point in a process where the next defined step in the workflow is not reachable or functional for some reason, and the user can press a ‘hold’ button. This may require a supervisor to input a special code to continue the workflow, create an exception for a given device, or allow some other output. The hold list in user interface 1400 can list all the devices subject to a supervisor hold. User interfaces 1600 and 1800 of FIGS. 9 and 10 illustrate a possible embodiment of research lookup functionality. A user may desire to lookup a device to get additional information. User interface 1600 can allow the user to enter a device or part ID, and interface 1800 displays the results, with additional information about the given device, component, part, etc.

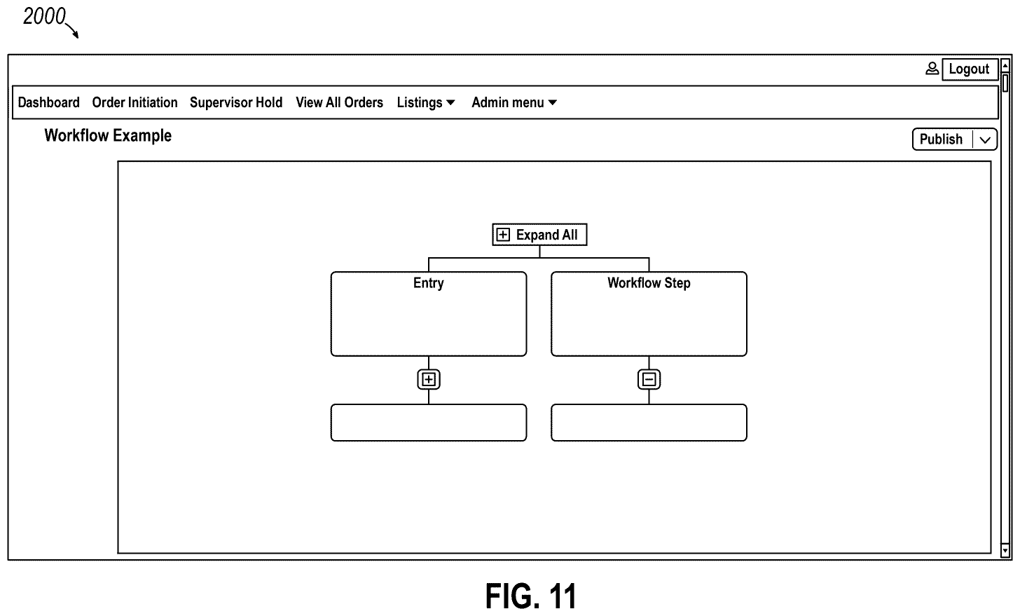

Certain embodiments allow a manager/user to create workflows, such as workflow 8 or workflow 200 and create and define the related decision trees, options, questions, instructions, and other actions comprising such workflows. For example, a user may use computing device 70, with a web/browser interface, or software application, to create workflows. Various examples are shown in FIGS. 11 to 17.

User interface 2000 of FIG. 11 is one example of a step editing interface. This example is shown with respect to a smart phone receive process. This could include, for example, creating user interface 220 of FIG. 2. Various actions, tasks, and other functions can be created and defined by a user. For example, certain templates are provided, including Task pages, Evaluation pages, Switch pages. Custom pages are also provided, allowing a user to create a custom task. Task pages can include templates for indicating a task to a worker. Evaluation pages can include various evaluation entries, for e.g., phone condition, screen condition, etc. Switch pages can include conditions for moving from one set of process/tasks to another. For example, regarding user interfaces 220, 230, 240 of FIG. 2, different entries on user interfaces 220, 230 can bring up different user interfaces 230, 240, as a decision tree created by the user will lead to different tasks or questions. As shown in FIG. 11, templates, or types of pages to design are listed on the left side of the user interface 2000. Steps or actions to add within a page/template are shown on the right side of the user interface 2000. Other variations are possible. A user could upload a variety of additional material for display to a worker upon the worker reaching a certain step in a process or workflow. For example, a video or pdf could be uploaded to be displayed to the worker. The video or pdf might have detailed instructions for performing a task, or could list factors for e.g., grading a smartphone's condition. User interface 2000 can provide options for radial buttons to display to a worker, text boxes to receive open ended text, drop down menus listing possible choices for data entry (e.g. a list of phone models to choose from to identify a phone being worked on), a check box for use by a worker, or other command or data entry tools.

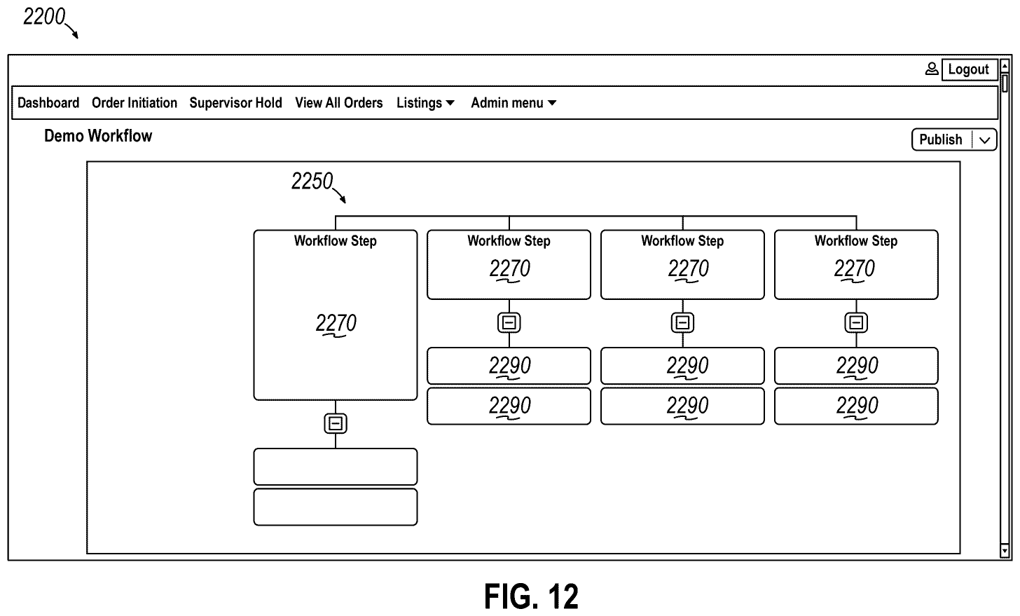

FIG. 12 illustrates a possible workflow 2250 (such as workflow 8 or workflow 200). A user can edit workflow 2250, in workflow editing interface 2200. Selecting a specific step 2270 in a workflow can allow the user to edit that step. Selecting a step 2270 may bring up e.g., a step editing interface 2000 of FIG. 11. Sub-steps 2290 can comprise discrete portions of a larger page or step 2270. Each sub-step 2290 can be edited within e.g., user interfaces 2200, 2000.

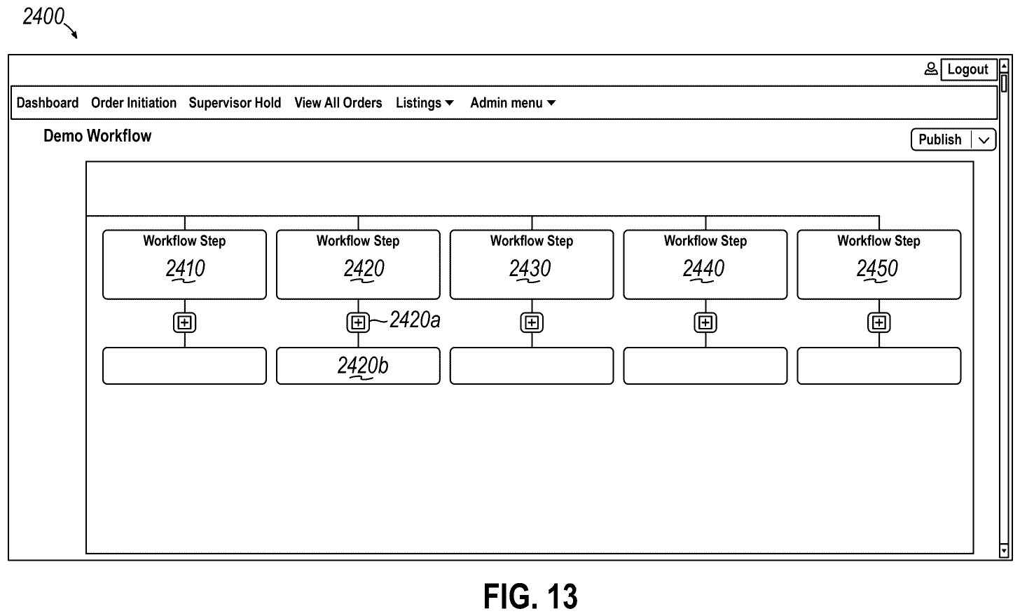

FIG. 13 displays another possible embodiment of a workflow editing interface 2400. Steps or tasks 2410, 2420, 2430, 2440, 2450 can comprise portions of a workflow. Workflow editing interface 2400 can allow a user to select any of tasks 2410-2450, or any sub-step or sub-task (e.g., 2420a, 2420b) to edit. As can be seen in FIG. 13, various options for editing can be found, e.g., workflow steps, end conditions, end assignments, evaluation item types, manage headers, manage API calls, manage task pages, etc. Others are possible. Workflow steps can allow a user to design a workflow by configuring steps within a workflow. End conditions can allow a user to manage the end conditions that define which workflow step is next. End assignments can allow a user to manage the end assignments that allow the user to define variable assignments for API interaction or workflow decisioning. Evaluation item types can allow a user to manage the evaluation item types to define custom user inputs. Manage headers can allow a user to manage headers that are displayed to user when working in a workflow. Manage API calls allows a user to manage API calls that the workflow will make it to update external systems or drive workflow decisions. Manage task pages can allow a user to define and edit task pages that are presented to the user during a workflow. As shown in user interface 2400, possible end conditions can be, e.g.:

• tokens.PUTAWAY_TYPE !== ‘KNP’;
• true;
• tokens.AA_START_DATETIME !== tokens.DATE_TIME_STAMP;
• or other conditions.

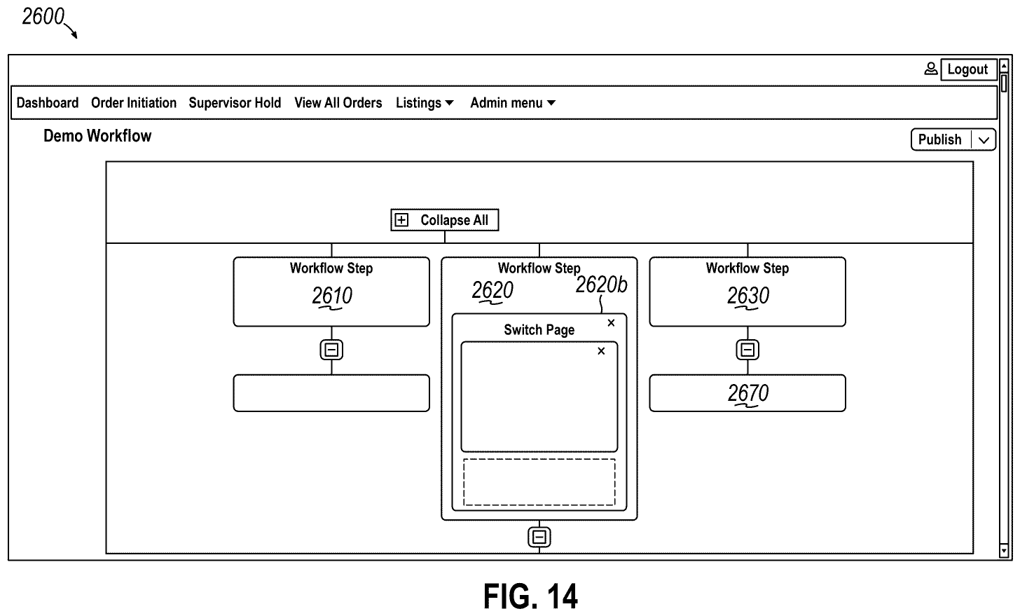

FIG. 14 displays another possible workflow editing interface 2600 for editing a workflow, with steps 2610, 2620, 2630. Here a user has selected one sub-task 2620b for editing. Editing sidebar 2670 is displayed and can allow the user a variety of ways to edit the sub-task. A user can give a name to a task/sub-task, define a next step, or edit other aspects.

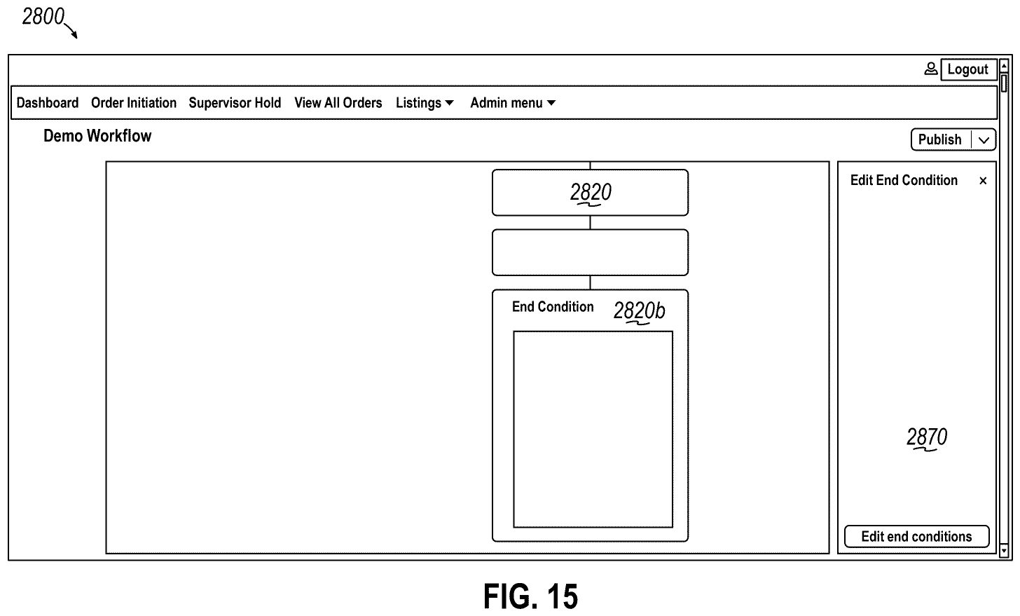

FIG. 15 displays another possible workflow editing interface 2800 for editing a workflow. Here task 2820 is shown and sub-task 2820b is being edited in sidebar 2870.

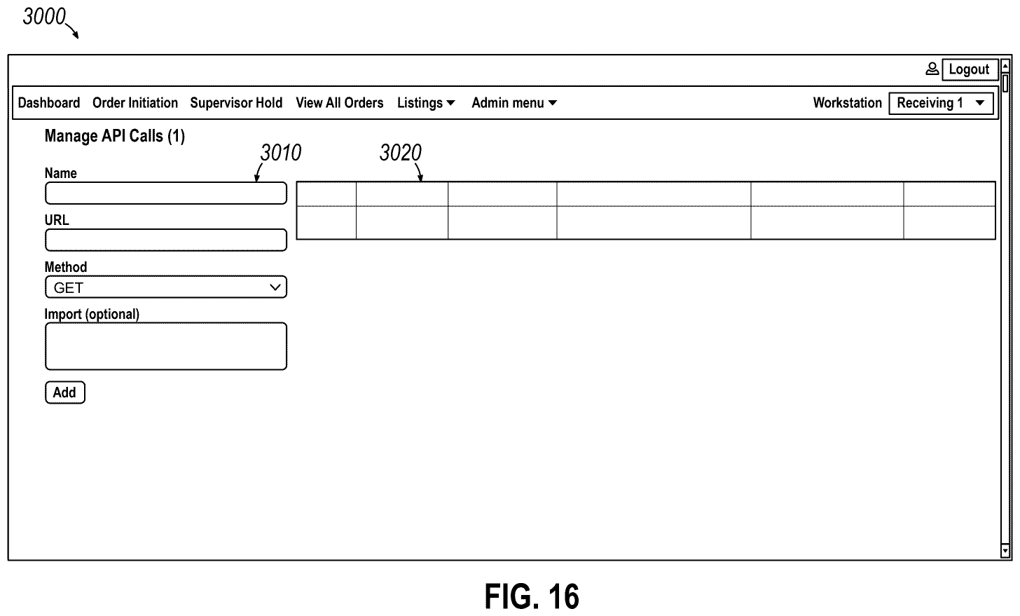

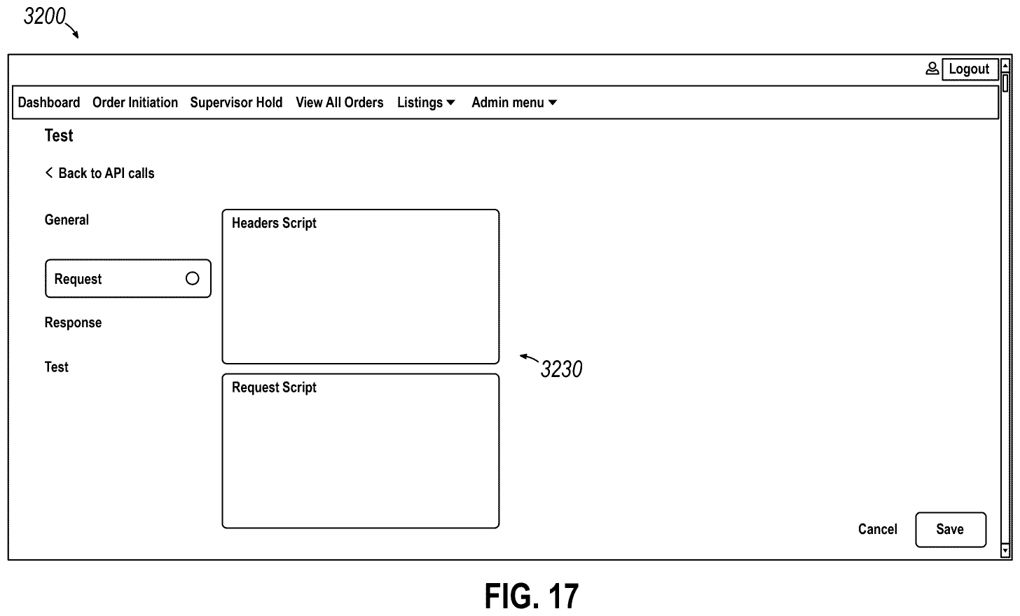

API calls can also be defined. An example is shown in FIG. 16 and FIG. 17. In API interface 3000 a user can set up a number of API calls for use in the user's workflows. API calls can be used to retrieve data from a data source, send data to a recipient, activate ancillary devices at a workstation, print shipping or phone labels, use a sanitizing/cleaning machine, use a conveyor belt, or perform other tasks. Add API function 3010 allows for additions of new APIs. List 3020 shows the list of created APIs. Clicking on an API in list 3020 can bring up sidebar 3230 shown in FIG. 17 in user interface 3200. Sidebar 3230 can allow the user to input various features of an API, e.g., URL, request, request script, response, authenticator, system, test, history, etc.

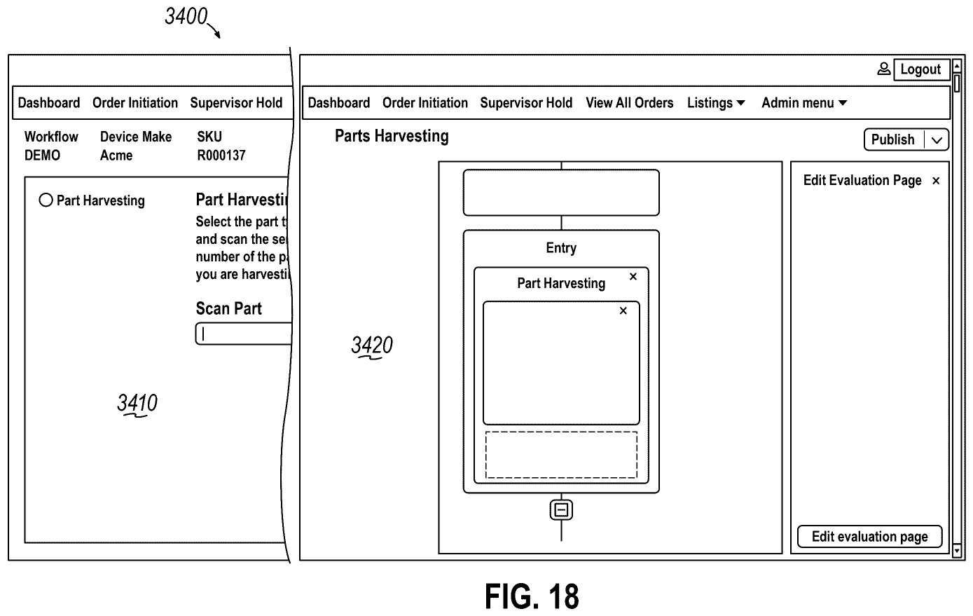

FIG. 18 shows a comparison of a user interface 3410 for a worker implementing a workflow called Part Harvesting. The editing user interface where Part Harvesting was created is shown in user interface 3420.

The user interfaces of FIGS. 2 to 18 show a variety of functionalities of certain embodiments. Other functionalities can be enabled by various embodiments as well. These include, at least, listing pages, dwell states, role-based access, view all orders, workflow locks, and others. Some further description is provided below.

Listing Pages: A user, e.g., an administrator, can define a step group, apply a step group to one or more workflow steps, then define listing pages that will show all orders that are currently in progress assigned to the workflow step in those defined groups. This can give operators visibility to in-progress orders at the steps that are important to them.

Dwell states: A user/admin can define dwell states for given workflow steps, similar to listing pages. The dwell state visualizer can give operators a view of orders that are currently in a given step defined by a step group. An additional configuration for dwell states allows the admin to configure a minimum wait time for that step that the operators must wait before completing the step. This is useful for tasks like charging that require a certain amount of time to complete.

Role based access: A user/admin can define any number of roles that can be assigned to users. Each workflow step can have a role defined to dictate who should have access to that workflow step. For example, a “Special Operators” role can be created, in a given workflow. The admin can add a workflow step that defines only users with role “Special Operators” can access that step, if a user does not have the role required, WipIT presents an error message if they attempt to access/complete the step.

View All Orders: Users/admins can access a page that allows them to view all orders in WipIT, along with the ability to search for and filter by various data points of the order. This feature allows users to cancel orders or view more details of a given order. All order data is available to be viewed, including the steps the order has gone through, the API calls that were made as part of that order, and all events/user selections made during the course of the order, including e.g., who initiated the action and at what time.

Workflow locks: To allow for fine grain operational control, the user/admin can lock a workflow, preventing orders from going through a workflow, to allow for emergent work stoppage from WipIT if needed operationally. Such workflow step configuration could include, e.g.:
Minimum enforced wait time: a minimum amount of time that needs to be spent on a given step can be optionally configured, this prevents the operator from quickly progressing past a step that requires a certain amount of time before it can be completed.
Halted step: allows the user/admin to specify that a step should halt the workflow and send a worker back to the order initiation screen. This is useful in the scenario where multiple operators need to complete a single workflow, e.g., the last step for operator A can be configured as Halted so operator A knows their tasks are complete and should pass off to operator B to continue.
Restrict previous user: allows a user/admin to specify that a given workflow step cannot be completed by the same user as the previous workflow step was completed by. This is useful in audit/double-check scenarios where you want to a workflow step to be completed by a different user than the previous step was completed by.
Permit step end expression: this allows a user/admin to configure an expression that defines whether or not a step can be completed. This is useful in scenarios where dynamic data associated with the order needs to be utilized in order to determine if the step is able to be completed.

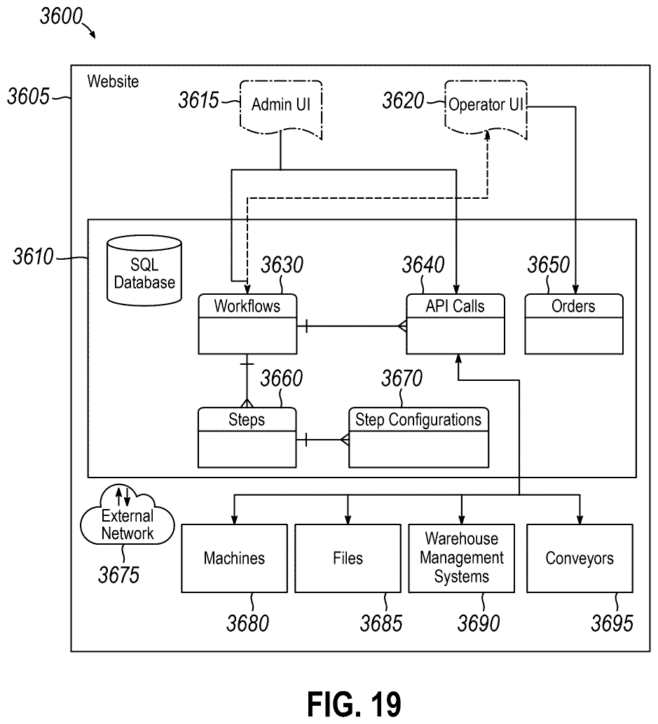

FIG. 19 shows how a database (e.g., SQL database) 3610 might be implemented to implement and collect data as necessary to carry out a workflow, such as the Part Harvesting workflow or other workflows as described herein. System 3600 can comprise e.g., portions of system 10 of FIG. 1, or help implement the functionalities described with respect to FIG. 1 and other descriptions herein. Database 3610 may store workflows 3630, comprising steps 3660 and step configurations 3670. Workflows 3630 may utilize APIs 3640, configured to interact with and implement various devices, such as machines 3680, files 3685, warehouse management system 3690, conveyors 3695, and/or other devices at e.g., a factory or warehouse. Database 3610 may be “on-prem” at a factory or warehouse with machines 3680, files 3685, warehouse management system 3690, and conveyors 3695, or may be cloud-based. External network 3675 may allow communicative coupling between database 3610 and machines 3680, files 3685, warehouse management system 3690, conveyors 3695. Database 3610 may comprise or communicate with admin UI 3615 and/or operator UI 3620. Admin UI 3615 allows admins/users to set up, configure and edit workflows 3630, and/or API calls 3640. Operator UI 3620 can be presented to operators in e.g., a warehouse who are performing tasks in a workflow. Workflows 3630 can be presented to operators via operator UI 3620 along with orders 3650 (such as a phone to be worked on). As an operator works on a workflow, database 3610 may collect data, either input by the operator or collected, such as images, video, time data, or other data, and may store the data related to a given workflow and a given order at order 3650. Preferably workflow 3630 remained unchanged by the operator and can be implemented without changes for the next operator who needs to use a given workflow 3630. At a given step in a workflow, the workflow 3630 may need to access an API call 3640 to enable a device, such as machines 3680, files 3685, warehouse management system 3690, or conveyors 3695. Admin UI 3615 and operator UI 3620 can be browser-based on a website 3605. But other embodiments are possible.

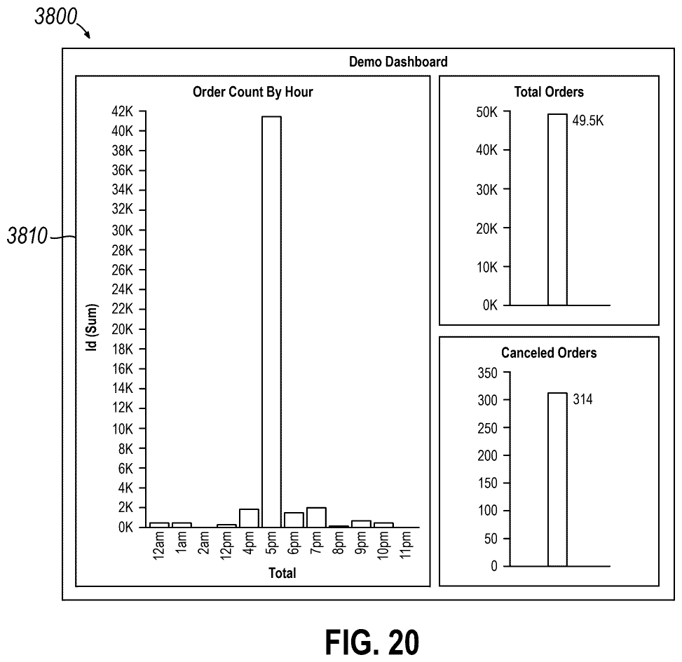

Further embodiments under the present disclosure can allow for data collection regarding workflows, workstations, and workers to allow for optimization of such processes. For example, user interface 3800 of FIG. 20 can track a number of processed units (e.g., smartphones, packages, etc.) during different hours of the day. Graph 3810 can track the total number of processed units. But other embodiments could show how different workstations are performing, or time spent per device divided by each worker in a warehouse, or other valuable data for assessing performance. Such data could show which workers are slower/quicker, or could show what steps within a workflow cause the most delay (helping to identify which steps need more work to optimize). Data can be tracked by e.g., computing devices 25, 35, 45 or machines 28, 38, 48 at workstations 20, 30, 40.

Additional functionalities are possible under certain embodiments under the present disclosure. For example, certain embodiments comprise the capability for guidance to appear in the administrative tools for assistance in learning the configurations.

Other embodiments can comprise a mechanism for administrative users to define custom variables (“tokens”) for their implementation. Some variation of this can comprise searchability and reportability on the tokens by administrative users. Certain embodiments can comprise a mechanism for a low-code environment in which token values can be retrieved and updated for a specific transaction within a workflow. Other embodiments may comprise the ability for administrative users to configure a workflow step as requiring external user approval, by use of a bearer token, so that the system does not require authentication of the external user.

Certain embodiments may comprise a mechanism used by the worker to view previous notes and leave new notes about a transaction or a set of transactions that match a specific key such as a Serial Number or IMEI.

Other embodiments can comprise the ability to create date-bound versions of workflows, providing for the ability to publish, unpublish, or schedule the publication of a workflow on some future date. Certain embodiments can comprise the ability to assign workstations to a group, and enforcement mechanisms to allow transactions for a workflow to be originated only from specific workstation groups.

Certain embodiments can comprise the ability for the system to automatically create the documentation for a workflow, including a visual flowchart representation of the workflow steps and their logical conditions that govern the flow from one step to the next, API calls, expression tokens used by the workflow, and page previews of each step.

Certain embodiments can comprise a configuration capability for what a worker would see on the screen when processing an order in a step (“web components” and “headers”), and the ability to assign the custom layout of the web components and preview these user interfaces in the workflow editing interface. Other embodiments can comprise the ability to manage test data which can be used to fully test an unpublished workflow. In other embodiments there can be a configuration for workflow-step specific (e.g., “Work Instructions”) document to be available to the worker when they are processing an order in a step.

### Configuring Tabular Data and User Dashboards

Certain embodiments can comprise a configuration capability for managing tabular data which can be used in the routing mechanisms (low-code platform). The tabular data can be manipulated from within the scripting engine that governs transactions progression through the workflow.

Certain embodiments can comprise a configuration capability to allow for the construction of inbound APIs, including the manner in which the incoming information is processed and how to respond to the external system invoking such APIs. Certain other embodiments can comprise a configuration capability for role-based access controls, including the creation of custom roles, assigning roles to users and configuration of the authorizations for workflow steps depending on the role of the user. Certain embodiments can comprise systems and methods for achieving extensibility, such as using a plug-in architecture which isolates customer-specific customizations from the core functionality.

Certain embodiments can comprise the ability to configure listing pages, which will show transactions in process assigned to one or more workflow steps. An administrator can configure which columns should be shown on the listing pages and users of the system can resume the workflows in flight. Such a feature allows transactions to be put “on hold” for any reason, and resumed once the blocking issue is resolved.

Certain embodiments can comprise the ability to configure a dwell state visualizer, which can be a special user interface that conveys information about e.g., a) percent complete while a device must wait in a process for some period of time (e.g. battery charging), or b) discrete status indicators (e.g. “pass”, “fail”, “in progress”). Certain embodiments can comprise the ability to group workflow steps together, and configure listing pages or dwell state visualizations that reference the workflow step groups. Certain embodiments can comprise the ability for the system to create documentation in a flowchart document which describes the workflow, its workflow steps and the routing rules that govern how a transaction progresses through the workflow.

Certain embodiments can comprise the capability for an administrative user to create a version-controlled library of custom functions which can be used in other parts of the system, and includes mechanisms for creating transactions, updating transactions, reading and writing records from custom tabular data and invoking APIs. Certain variations can comprise a built-in workflow template library to provide examples of common logistics workflows.

Certain embodiments can comprise providing a visualization dashboard to workers. Certain variations can include the configurability of the dashboards, so that an administrative user can select which visualizations are made visible in the dashboards.

Certain embodiments comprise the ability to download data from the data store in tabular (CSV) format. Certain embodiments can comprise the ability for the system to regularly transfer data to a host system using a Data Integration Service. Other embodiments comprise the ability for an administrator to create report templates and subscription mechanisms to deliver the reports to recipients by email.

Other embodiments can comprise a job-scheduling mechanism for system administrators to establish repeating jobs to run on a timer (cron) schedule. Certain embodiments include the ability to search for transactions and view details of the transaction, including workflow step history, token value, event history and full audit history of all mutations and API calls that occurred on the transaction.

Certain embodiments can include support for configuration of segment hierarchies, to which users, transactions and workflows can be assigned, for the purpose of providing logical separation between one segment's data and another, while maintaining workflow configurations across multiple segments, thereby enforcing all users at assigned to a segment to adhere to common workflows, and to allow administrators to assign specific workflows to segment(s).

Certain embodiments include methods and systems for an AI-based assistant with access to a large language model to provide help to the worker about the transaction they are working with. Certain embodiments can include an AI-based assistant with access to a large language model to provide help to the administrative user when editing a workflow.

Certain embodiments can include a Materials Management Module, which can be used to track available inventory, including activities such as Put Away (receive inventory), Fulfill (deduct inventory) and Reconcile (cycle count). Certain variations can include a built-in integration library from the workflow system's low code platform to the Materials Management Module.

Certain embodiments can include the ability to capture a digital signature as a web component, used in a workflow step. Certain embodiments can include the ability for external users to access the data in a B2B and B2C portal. Certain variations can include a B2C portal with a Directed Service module which informs an external user which location they should go to for service.

### AI/ML Embodiments

Some embodiments under the present disclosure can use machine learning (ML) or artificial intelligence (AI) to detect flaws in a workflow or otherwise improve performance. For example, computing device 70 and/or servers 80 of FIG. 1 can perform ML-based methods such as such as described herein, for e.g., analyzing what tasks are most time consuming, what workers are most efficient, predicting what types of tasks most need detailed instructions, or other factors. Optimizing these factors may lead to savings over time. In certain embodiments computing device 70 and/or servers 80 can comprise a ML/AI engine (or in other components) for training or implementing a ML/AI model. The architecture of an ML model (e.g., structure, number of layers, nodes per layer, activation function etc.) may need to be tailored for each particular use case. For example, properties to vary can include e.g.: task information, phone manufacturer, shipping address, personnel numbers, local weather, local altitude, worker name, number of steps in a workflow, API information, and a variety of other factors. These may all need to be considered when designing the ML model's architecture.

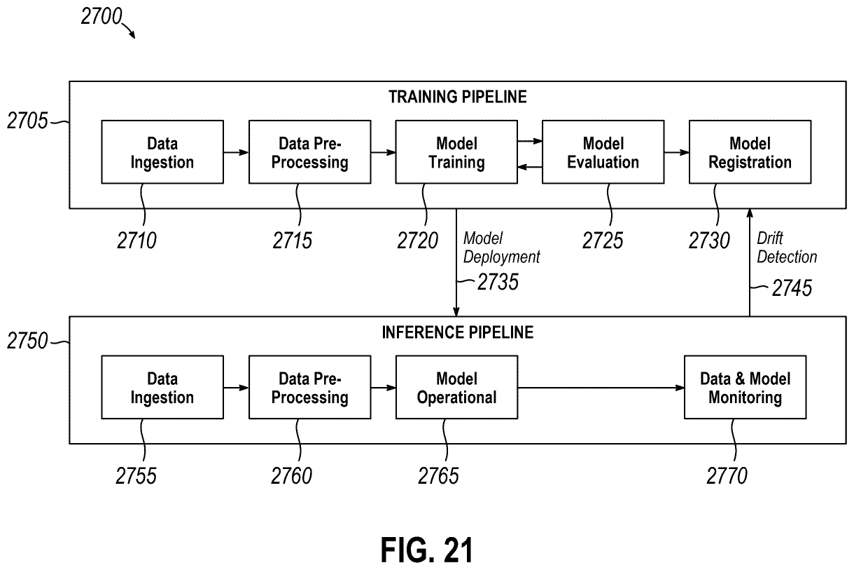

Building an AI/ML model includes several development steps where the actual training of the ML model is just one step in a training pipeline. An important part in AI/ML development is the AI/ML model lifecycle management. One embodiment of a model lifecycle management procedure 2700 is illustrated in FIG. 21. The model lifecycle management comprises two pipelines: a training pipeline 2705 and an inference pipeline 2750.

At 2710 in the training pipeline 2705, data ingestion 2710 occurs, which includes gathering raw (training) data from a data storage. After data ingestion 2710, there may also be a step that controls the validity of the gathered data. At 2715 data pre-processing occurs, which can include feature engineering applied to the gathered data. This may involve, e.g., data normalization or data formatting or transformation required for the input data to the AI/ML model. After the ML model's architecture is fixed, it should be trained on one or more datasets. At 2720 model training is performed in which the AI/ML model is trained with the raw training data. To achieve good performance during live operation in a system (the so-called inference phase), the training datasets should be representative of actual data the ML model will encounter during live operation. The training process often involves numerically tuning the ML model's trainable parameters (e.g., the weights and biases of the underlying neural network (NN)) to minimize a loss function on the training datasets. The loss function may be, for example, based on a maximum/minimum spend on tools or supplies, a maximum/minimum speed of performing a task, or other output. The purpose of the loss function is to meaningfully quantify the reconstruction error for the particular use case at hand. At 2725 model evaluation can be performed where the performance is benchmarked to some baseline. Model training 2720 and evaluation 2725 can be iterated until an acceptable level of performance is achieved. At 2730 model registration occurs, in which the AI/ML model is registered with any corresponding data on how the AI/ML model was developed, and e.g., AI/ML model evaluation data. At 2735 model deployment occurs, wherein the trained/re-trained AI/ML model is implemented in the inference pipeline 2750.

Data ingestion 2755 in the inference pipeline 2750 refers to gathering raw (inference) data from a data source. Data pre-processing 2760 can be essentially identical/similar to the data pre-processing 2715 of the training pipeline 2705. At 2765, the operational model received from the training pipeline 2705 is used to process new data received during operation of e.g., workflows as described above. At 2770 data and model monitoring is performed. Here the inference data is analyzed to determine whether the inference data are from a distribution that aligns with the training data, as well as monitoring model outputs for detecting any performance, or operational, variance or drifts. The variance or drift is used at 2745 (drift detection) to update the AI/ML model registration.

The training process is typically based on some variant of a gradient descent algorithm, which, at its core, can comprise three components: a feedforward step, a back propagation step, and a parameter optimization step. It is preferred to make small adjustments to each parameter used with the aim of reducing the average loss over the (mini) batch. It is common to use special optimizers to update the ML model's trainable parameters using gradient information. The following optimizers are widely used to reduce training time and improving overall performance: adaptive sub-gradient methods (AdaGrad), RMSProp, and adaptive moment estimation (ADAM). Other embodiments are possible.

The above process (feedforward, back propagation, parameter optimization) can be repeated many times until an acceptable level of performance is achieved on the training dataset. An acceptable level of performance may refer to the ML model achieving a pre-defined average reconstruction error over the training dataset (e.g., normalized MSE of the reconstruction error over the training dataset is less than, say, 0.1). Alternatively, it may refer to the ML model achieving a pre-defined value chosen by a user.

In some implementations, a function F(⋅) may be generated by a ML process, such as, for example, supervised learning, reinforcement learning, and/or unsupervised learning. It should further be understood that supervised learning may be done in various ways, such as, for example, using random forests, support vector machines, neural networks, and the like. By way of non-limiting example, any of the following types of neural networks that may be utilized, including, deep neural networks (DNNs), convolutional neural networks (CNNs), and recurrent neural networks (RNNs), or any other known or future neural network that satisfies the needs of the system. In an implementation using supervised learning the neural networks may be easily integrated into the hardware or software described in system 10 of FIG. 1 (e.g., in the form of simple vector-matrix multiplications).

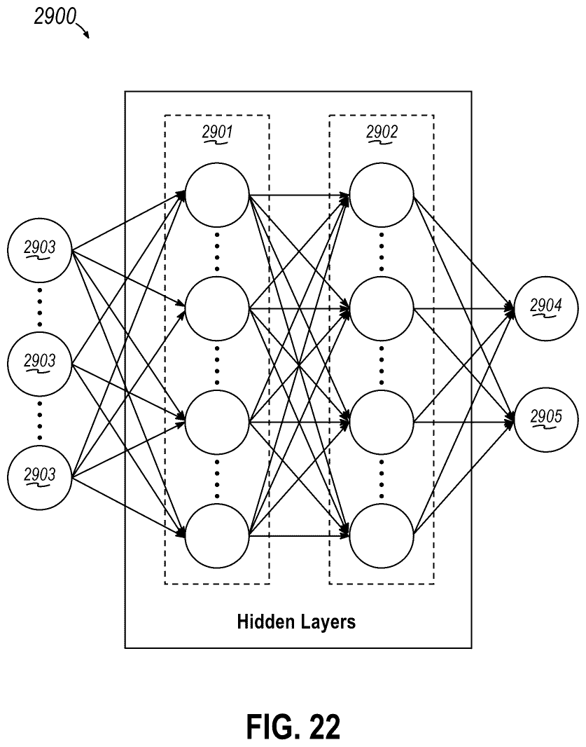

Referring now to FIG. 22, an example NN 2900 (e.g., DNN) is shown. In some implementations, and as shown, the neural network 2900 may include two hidden layers represented by dashed boxes 2901 and 2902. In one implementation, the inputs 2903 may be fed into the NN 2900. Next, the inputs 2403 may go through a set of hidden layers (e.g., 2901 and/or 2902). Once the inputs 2903 pass though the hidden layers 2901 and/or 2902, they may be output (e.g., as an output layer) as e.g., time spent on a given task/sub-tasks, personnel costs, equipment costs, or other factors desired to be optimized. Possible inputs can include e.g.: employee identification, types of tasks, device identifications (e.g., smartphone models), or a variety of other data.

As should be understood by one of ordinary skill in the art, in order for the NN 2900 to output a proper analysis, it should be trained properly (e.g., with a collection of samples) to accurately extract the likelihood values. If not trained properly, overfitting (e.g., when the NN memorizes the structure of the preambles but is unable to generalize to unseen preamble characteristics) or underfitting (e.g., when the NN is unable to learn a proper function even on the data that it was trained on) may happen. Thus, implementations may exist that prevent overfitting or underfitting, involving a set of well-engineered features that must be extracted from the preamble characteristics.

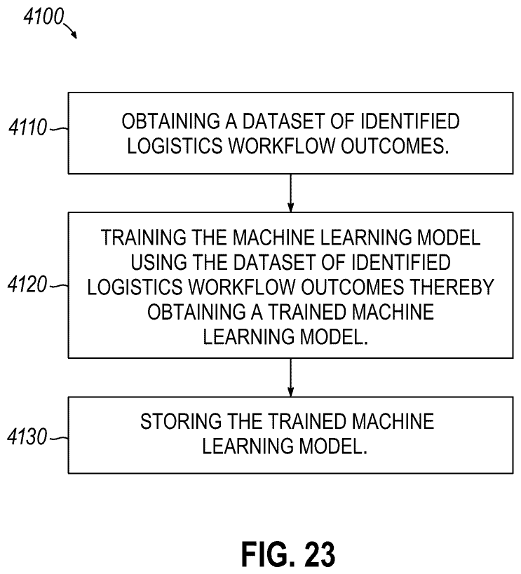

FIG. 23 illustrates a possible method embodiment under the present disclosure. Method 4100 comprises a computer implemented method for training a machine learning model for optimizing a workflow implementation system. Step 4110 is obtaining a dataset of identified logistics workflow outcomes. Step 4120 is training the machine learning model using the dataset of identified logistics workflow outcomes thereby obtaining a trained machine learning model. Step 4130 is storing the trained machine learning model. Method 4100 can comprise a variety of additional, alternative, and/or optional steps. For example, method steps can further comprise training a machine learning model for optimizing identified logistics workflow outcomes, wherein the training comprises; training the machine learning model using a dataset of one or more identified logistics workflow outcomes, thereby obtaining a further trained machine learning model; and storing the further trained machine learning model. In some variations, the one or more identified logistics workflow outcomes comprise one or more of: time spent on one or more steps comprising a logistics workflow; personnel costs; equipment costs, or other desired metrics for analysis. In other possible embodiments, the machine learning model uses one or more inputs comprising one or more of: employee identification; types of tasks; device identifications; an identification of one or more machines used in a logistics workflow; one or more characteristics of one or more steps in a logistics workflow; or other possible inputs into the workflow, steps, workstations, computing device, or machines.

### Additional Embodiments

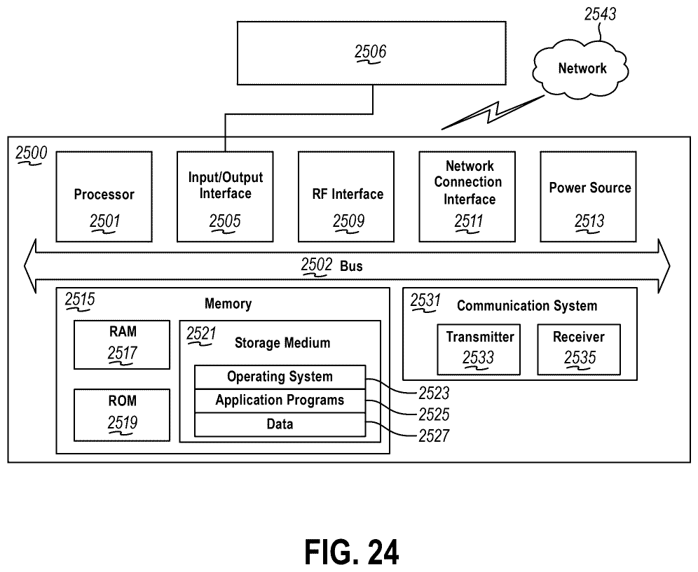

FIG. 24 illustrates an embodiment of various computing devices within e.g., system 10 of FIG. 1, or components thereof. FIG. 24 shows a schematic block diagram of a computing device 2500 (or components thereof) according to certain embodiments of the present disclosure. System 2500 can be used to analyze and/or optimize: the functionalities described with respect to e.g., computing devices 25, 35, 45, computing device 70, servers 80, other devices, or to perform ML-related tasks and analyses as described herein.

Computing device 2500 includes processor 2501 that is operatively coupled via a bus 2502 to an input/output interface 2505, a power source 2513, a memory 2515, a RF interface 2509, network communication interface 2511, and/or any other component, or any combination thereof. The level of integration between the components may vary from one embodiment to another. Further, certain computing devices 2500 (or components thereof) may contain multiple instances of a component, such as multiple processors, memories, transceivers, transmitters, receivers, etc.

The processor 2501 is configured to process instructions and data and may be configured to implement any sequential state machine operative to execute instructions stored as machine-readable computer programs in memory 2515. Processor 2501 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 2501 may include multiple central processing units (CPUs).

In the example, input/output interface 2505 may be configured to provide an interface or interfaces to an input/output device(s) 2506, such as a screen, keyboard, indicator light, keypad, touchscreen, or other input or output device. Other examples of an output device include a speaker, a sound card, a video card, a display, a monitor, a printer, an actuator, an emitter, a smartcard, another output device, or any combination thereof. An input device may allow a user to capture information into system 2500. Other examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2513 is structured as a battery or battery pack. Other types of power sources, such as an external power source (e.g., an electricity outlet), photovoltaic device, or power cell, may be used. The power source 2513 may further include power circuitry for delivering power from the power source 2513 itself, and/or an external power source, to the various parts of computing device 2500 via input circuitry or an interface such as an electrical power cable.

Memory 2515 may be configured to include memory such as random-access memory (RAM) 2517, read-only memory (ROM) 2519, programmable read-only memory (PROM), erasable programmable read-only memory (EPROM), electrically erasable programmable read-only memory (EEPROM), magnetic disks, optical disks, hard disks, removable cartridges, flash drives, other storage medium 2521, and so forth. In one example, the memory 2515 includes one or more application programs 2525, an operating system 2523, web browser application, a widget, gadget engine, or other application, and corresponding data 2527. Memory 2515 may store, for use by the computing device 2500, any of a variety of various operating systems or combinations of operating systems. An article of manufacture, such as one including a simulation system or communication system may be tangibly embodied as or in memory 2515, which may be or comprise a device-readable storage medium.

Processor 2501 may be configured to communicate with an access network or other network using the RF interface 2509 or network connection interface 2511. The RF interface 2509 or network connection interface 2511 may comprise one or more communication subsystems and may include or be communicatively coupled to an antenna. In the illustrated embodiment, communication functions of the RF interface 2509 or network connection interface 2511 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

Although the computing devices described herein (e.g., computers, laptops, smartphones, servers, etc.) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining or similar operations described herein may be performed by processing circuitry, which may process information by, for example, converting the obtained information into other information, comparing the obtained information or converted information to information stored in the computing device or elsewhere, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking on a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be affected to the particular embodiments by those of skill in the art without departing from the scope of the description, which is defined solely by the appended claims.

What is claimed is:

1. A system for dynamically managing logistics-based workflows at one or more workstations, the system comprising:
one or more workstations operable by one or more workers to complete one or more steps in a workflow;
one or more computing devices located at the one or more workstations, each of the one or more computing devices configured to display respective steps of the one or more steps that are associated with each respective workstation of the one or more workstations, the respective steps to be completed by a respective worker of the one or more workers;
at least one machine coupled to at least one workstation of the one or more workstations, the at least one machine operable by a respective worker of the one or more workers to complete respective steps of the one or more steps in the workflow; and
at least one manager computing device coupled to the one or more computing devices and configured to provide the respective steps to each of the one or more computing devices, the at least one manager computing device further configured to allow a user to edit the one or more steps and to create one or more application programming interfaces (A Pls) for implementing the respective steps for completion by the at least one machine.

2. The system of claim 1, wherein the one or more machines comprise one or more of: a conveyor belt; a packaging machine; a cleaning machine; a camera; a sanitizing machine; a postage machine.

3. The system of claim 1, wherein the at least one manager computing device comprises one or more of: a computer; one or more laptops; one or more servers; one or more smartphones; a database.

4. The system of claim 1, wherein the at least one manager computing device is operable to allow the user to create a version-controlled library of custom functions which can be used by at least one of: the one or more workstations; the one or more computing devices; the at least one machine.

5. The system of claim 1, wherein the at least one manager computing device comprises a built-in workflow template library to provide examples of common logistics workflows.

6. The system of claim 1, wherein the at least one manager computing device is operable to provide the one or more computing devices an artificial intelligence (AI)-based assistant for use by the one or more workers at the one or more computing devices.

7. The system of claim 1, wherein the one or more computing devices are operable to capture a digital signature as a web component, used in a workflow step.

8. The method of claim 1, wherein the workflow comprises at least one of: a process for recycling a smartphone; a process for shipping a smartphone; a process for packing and addressing mail.

9. A method of dynamically managing logistics-based machines with associated workflows, the method comprising:
presenting, to a user via at least one manager computing device, a workflow editing interface to allow the user to create a workflow defining;
one or more steps of the workflow to be completed by one or more workers;
one or more workstations operable by one or more workers to complete the one or more steps;
one or more computing devices located at the one or more workstations, each of the one or more computing devices configured to display respective steps of the one or more steps that are associated with each respective workstation of the one or more workstations, the respective steps to be completed by a respective worker of the one or more workers; and
at least one machine coupled to at least one workstation of the one or more workstations, the at least one machine operable by a respective worker of the one or more workers to complete respective steps of the one or more steps in the workflow;
presenting, to the user via the at least one manager computing device, an application programming interface, API, dashboard to allow the user to create one or more APIs for implementing the at least one machine into the workflow;
transmitting each respective step to each respective computing device for display to the one or more workers; and
implementing the at least one machine via the one or more APIs.

10. The method of claim 9, further comprising collecting one or more data points by the one or more computing devices.

11. The method of claim 9, wherein the one or more machines comprise one or more of: a conveyor belt; a packaging machine; a cleaning machine; a camera; a sanitizing machine; a postage machine.

12. The method of claim 9, wherein the at least one manager computing device comprises one or more of: a computer; one or more laptops; one or more servers; one or more smartphones; a database.

13. The method of claim 9, further comprising receiving, from the user, a version-controlled library of custom functions which can be used by at least one of: the one or more workstations; the one or more computing devices; the at least one machine.

14. The method of claim 9, wherein the at least one manager computing device comprises a built-in workflow template library to provide examples of common logistics workflows.

15. The method of claim 9, wherein the at least one manager computing device is operable to provide the one or more computing devices an artificial intelligence (AI)-based assistant for use by the one or more workers at the one or more computing devices.

16. The method of claim 9, further comprising receiving, from the one or more computing devices as part of the one or more steps, a digital signature as a web component.

17. A computer implemented method for training a machine learning model for optimizing a workflow implementation system, the method comprising:
obtaining a dataset of identified logistics workflow outcomes;
training the machine learning model using the dataset of identified logistics workflow outcomes thereby obtaining a trained machine learning model, and
storing the trained machine learning model.

18. The method of claim 17, further comprising training a machine learning model for optimizing identified logistics workflow outcomes, wherein the training comprises;
training the machine learning model using a dataset of one or more identified logistics workflow outcomes, thereby obtaining a further trained machine learning model; and
storing the further trained machine learning model.

19. The method of claim 17, wherein the one or more identified logistics workflow outcomes comprise one or more of: time spent on one or more steps comprising a logistics workflow; personnel costs; equipment costs.

20. The method of claim 17, wherein the machine learning model uses one or more inputs comprising one or more of: employee identification; types of tasks; device identifications; an identification of one or more machines used in a logistics workflow; one or more characteristics of one or more steps in a logistics workflow.
